(19) United States
(12) Patent Application Publication
(10) Pub. No.: US 2026/0309971 A1
(43) Pub. Date: Oct. 8, 2026

(54) APPARATUS FOR AN OPTICAL IMAGING SYSTEM, OPTICAL IMAGING SYSTEM, METHOD AND COMPUTER PROGRAM

(71) Applicant: Leica Instruments (Singapore) Pte. Ltd., Singapore (SG)

(72) Inventors: Linqi JIAO, Singapore (SG); Dennis BREITSPRECHER, Singapore (SG)

(21) Appl. No.: 19/480,835

(22) PCT Filed: May 4, 2024
(86) PCT No.: PCT/EP2024/062370

§ 371 Date: Nov. 3, 2025

(30) Foreign Application Priority Data
May 4, 2023 (WO) PCT/CN2023/092006
Jun. 28, 2023 (DE) 10 2023 117 092.9

(51) Int. Cl. G02B 21/36; G01B 9/04; G02B 21/00; G06F 3/04817

(52) U.S. Cl. CPC G02B 21/368; G01B 9/04; G02B 21/0016; G02B 21/367; G06F 3/04817

(57) ABSTRACT

Examples relate to an apparatus for an optical imaging system, comprising one or more processors and one or more storage devices. The apparatus is configured to receive sensor data of a sensor of the optical imaging system. The sensor data is received from the optical imaging system, e.g., from the sensor. The sensor data is indicative of a live view of the sample through a microscope of the optical imaging system. Further, the apparatus is configured to generate a visual overlay comprising a visual representation of the live view and the icon. The visual overlay is generated based on the sensor data. Further, the apparatus is configured to transmit a display signal indicative of the visual overlay.

### CROSS REFERENCE TO RELATED APPLICATIONS

This application is a U.S. National Phase application under 35 U.S.C. § 371 of International Application No. PCT/EP 2024/062370, filed on May 4, 2024, and claims benefit to International Application No. PCT/CN 2023/092006, filed on May 4, 2023 and German Patent Application No. DE 10 2023 117 092.0, filed on Jun. 28, 2023. The International Application was published in English on Nov. 7, 2024 as WO 2024/227952 A1 under PCT Article 21(2).

### FIELD

Examples of the present disclosure relate to an optical imaging system, such as an optical imaging system used in industrial settings to monitor and control a quality of a manufacturing process or work piece, and to an optical imaging system, a method, and a computer program.

### BACKGROUND

Optical imaging system are often used in industrial and manufacturing settings for the purpose of monitoring and controlling the quality of processes or work pieces. The optical imaging system may feature digital imaging systems, video capabilities, and precision measurement tools, which allow users to quickly and accurately inspect samples and work pieces, such like products, during or after the manufacturing process. In addition, they often have automated analysis systems that can provide real-time feedback to production lines, further streamlining the quality process control. A software component of the measurement set is typically established through the use of specialized software that is designed to work with the microscope. However, the software component may be not sufficient to adjust needed parameters by a user. Thus, there may be a desire for an improved concept for providing a user a possibility to set up a measurement for process control.

### SUMMARY

In an embodiment, the present disclosure provides an apparatus for an optical imaging system includes one or more processors and one or more storage devices. The apparatus is configured to receive, from the optical imaging system, sensor data of a sensor of the optical imaging system, where the sensor data is indicative of a live view of a sample through a microscope of the optical imaging system. The apparatus is further configured to generate, based on the sensor data, a visual overlay comprising a visual representation of the live view and an icon indicative of a plurality of possible actions associated with a measurement, and transmit a display signal indicative of the visual overlay.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic diagram of an example of an apparatus for an optical imaging system;

FIG. 2 shows an example of multiple possible actions;

FIG. 3 shows a schematic illustration of a system;

FIG. 4 shows a flow chart of an example of a method; and

FIG. 5 shows a flow chart of another example of a method.

### DETAILED DESCRIPTION

Embodiments of the present disclosure are based on the insight that setting up a measurement for process control can be facilitated by providing an icon indicative of a plurality of possible actions associated with the measurement. The icon may be provided in a visual overlay with the live view of the sample. Thus, a user can select the icon in the live view window.

Examples provide an apparatus for an optical imaging system, comprising one or more processors and one or more storage devices. The apparatus is configured to receive sensor data of a sensor of the optical imaging system. The sensor data is received from the optical imaging system, e.g., from the sensor. The sensor data is indicative of a live view of the sample through a microscope of the optical imaging system. Further, the apparatus is configured to generate a visual overlay comprising a visual representation of the live view and the icon. The visual overlay is generated based on the sensor data. The icon is indicative of the plurality of possible actions associated with the measurement. Further, the apparatus is configured to transmit a display signal indicative of the visual overlay, e.g., to a display device. In this way, the display device can be controlled to display or can be triggered to display the live view of the sample and an icon to facilitate setting up a measurement for process control, for example. An action can be a generation of a geometry element and/or a selection of a measurement parameter. For example, the icon may be indicative of a plurality of actions needed to define the measurement, e.g., a dimensional measurement.

In an example, the apparatus may be further configured to receive a trigger signal indicative of selection of the icon by the user and generate a second visual overlay comprising a visual representation of the live view and a visual presentation of the plurality of possible actions. The generation of the second visual overlay is based on the sensor data and the trigger signal. Further, the apparatus may be configured to transmit a second display signal indicative of the second visual overlay, e.g., to the display device. By generating the second visual overlay the apparatus can control or trigger the display device to display auxiliary information for the user, e.g., which geometry element, measurement parameter can be selected for setting up the measurement, for example. In this way, the user can be informed in a facilitated way about possible adjustments that can be done to set up a measurement for process control.

In an example, the apparatus may be further configured to receive a second trigger signal indicative of an increased likelihood to select an action of the plurality of possible actions. The selection may be performed by user. Further, the apparatus may be configured to adapt the second visual overlay by highlighting the action (with an increased likelihood to be selected) of the plurality of possible actions. The adaption is based on the second trigger signal. Further, the apparatus may be configured to transmit the adapted second display signal, e.g., to the display device. The increased likelihood to select the action may be caused by an intention of the user. For example, the user may move a mouse cursor close to a geometry element. This movement may be indicative of an intention of the user to select the geometry element. Thus, the apparatus can highlight the geometry element close to or below the mouse cursor. In this way, the user can be informed in a facilitated way about a geometry element and/or a measurement parameter he can select.

In an example, the second visual overlay may be to highlight a measurement parameter and/or a pre-existing geometry element. In this way, the user can receive a visual feedback before performing a selection. This may increase a user experience since the selection can be performed with a higher reliability, for example.

In an example, the second visual overlay may comprise a representation of each possible action of the plurality of actions associated with the selected icon. In this way, the user can receive a visual feedback for every possible action associated with the selected measurement. Thus, the user can be informed about each possibility for setting up the measurement.

In an example, the multiple possible actions may comprise generating a geometry element and/or defining a measurement parameter. In this way, a measurement for process control can be fully defined based on the multiple possible actions. Thus, a user can use a facilitated workflow to generate the measurement for process control.

In an example, the multiple possible actions may comprise different geometry elements to be generated and/or selected. For example, multiple geometry elements for the sample may be already defined, also referred to as pre-existing geometry elements. Thus, the user can select an appropriate geometry element from the pre-existing geometry elements. For example, different geometry elements of the multiple geometry elements may belong to different measurements. In this way, the user can easily select a desired geometry element.

In an example, the multiple possible actions may comprise different measurement parameters to be defined. For example, a dimensional measurement to measure a distance between a primary geometry element and a secondary geometry element may be desired by user. However, the primary geometry element may be a circle and the distance to be measured can be a distance from a center of the circle or an edge of the circle. Thus, different measurement parameters can be displayed to the user. In this way, the user can easily select a desired measurement parameter.

In an example, the apparatus may be further configured to receive a third trigger signal indicative of a selection of the pre-existing geometry element by the user. Further, the apparatus may be configured to generate the second visual overlay and/or the adapted second visual overlay based on the third trigger signal. For example, if multiple geometry elements are needed for defining a measurement, the apparatus can highlight only geometry elements which can be used in conjunction with the selected pre-existing geometry element. In this way, setting up the measurement can be facilitated.

In an example, the selected pre-existing geometry element may be a primary geometry element and the adapted second visual overlay may comprise a highlight of a possible secondary geometry element. In this way, a user can receive information about a secondary geometry element associated with the primary geometry. The primary geometry element and the secondary geometry element may be geometry elements required for setting up/to run a measurement.

In an example, the apparatus may be further configured to receive a fourth trigger signal indicative of selection of an action of the plurality of possible actions and generate a geometry element and/or perform a measurement based on the fourth trigger signal. In this way, the apparatus can perform certain measures to allow setting up and/or run the measurement for process control.

Embodiments of the present disclosure provide an apparatus as described herein, e.g., above or below.

Embodiments of the present disclosure provide a method for an apparatus for an optical imaging system. The method comprises receiving, from the optical imaging system, sensor data of a sensor of the optical imaging system, the sensor data indicative of a live view of a sample through a microscope of the optical imaging system. The method further comprises generating, based on the sensor data, a visual overlay comprising a visual representation of the live view and an icon indicative of a plurality of possible actions associated with a measurement and transmitting a display signal indicative of the visual overlay.

Various examples of the present disclosure relate to a corresponding computer program with a program code for performing the above method when the computer program is executed on a processor.

Various examples will now be described more fully with reference to the accompanying drawings in which some examples are illustrated. In the figures, the thicknesses of lines, layers and/or regions may be exaggerated for clarity.

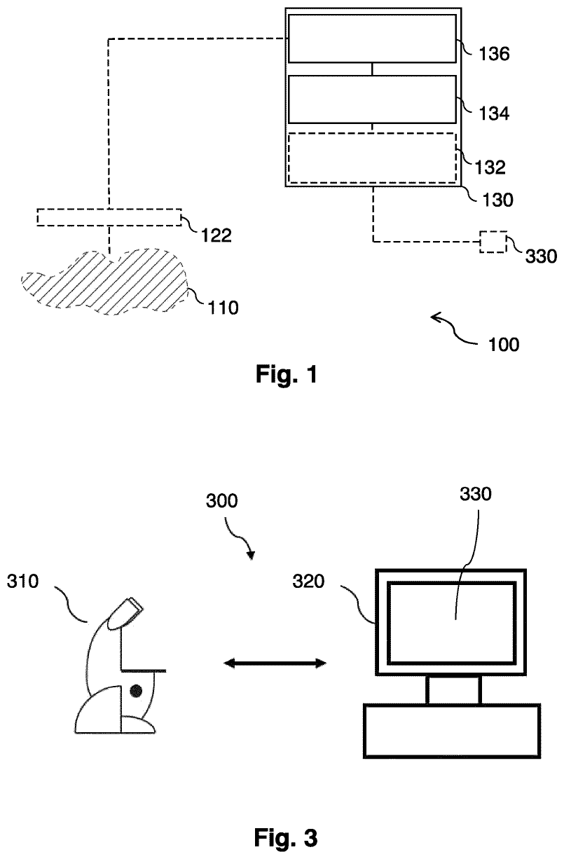

FIG. 1 shows a schematic diagram of an example of an apparatus 130 for an optical imaging system 100. The apparatus 130 is tasked with controlling various aspects of a microscope of the optical imaging system 100, which may be an optical imaging system 100 for process control in industrial settings, and of the entire optical imaging system 100 and/or with processing various types of sensor data of the optical imaging system 100. Consequently, the apparatus 130 may be implemented as a computer system, which interfaces with the various components of the optical imaging system 100, e.g., the sensor 122.

The apparatus 130 comprises, as shown in FIG. 1, one or more processors 134 and one or more storage devices 136. Optionally, the apparatus 130 further comprises one or more interfaces 132. The one or more processors 134 are coupled to the one or more storage devices 136 and to the optional one or more interfaces 132. In general, the functionality of the apparatus 130 may be provided by the one or more processors 134 (e.g., for generating the display signal), in conjunction with the one or more interfaces 132 (for exchanging data, e.g., with the sensor 122 to receive the sensor data, the display device 330 to transmit the display signal) and/or with the one or more storage devices 136 (for storing and/or retrieving data).

The apparatus 130 is configured to receive sensor data of a sensor of the optical imaging system 100. The sensor data is received from the optical imaging system 100, e.g., from the sensor 122, a frame buffer, a storage device. The sensor data is indicative of a live view of the sample 110 through a microscope of the optical imaging system 100. The live view may be acquired by the sensor 122. The sample 110 may be a sample under test. For example, the sample 110 may be a work piece of an industrial manufacturing process. For example, the optical imaging system 100 may be configured for a process control of the sample 110. The optical imaging system 100 may be designed for use in a laboratory or factory environment. The optical imaging system 100 can be used to inspect the sample 110, such like a product, during the manufacturing process to ensure that it meets required specifications and standards.

The optical imaging system 100 may be equipped with features such as digital imaging (e.g., the sensor 122), video capabilities (e.g., a display device 330), and precision measurement tools, which allow users, such like technicians, to identify defects, monitor changes in a manufacturing process, and/or make adjustments as necessary to ensure product quality. In addition, many process control microscopes have automated systems that can quickly analyze images and provide feedback to production lines, further streamlining the quality process control. However, there may be a need for adjusting the measurement for process control, e.g., to compensate for systematic errors caused by changes in a manufacturing process or set up a measurement for a new work piece.

The apparatus 130 is configured to generate a visual overlay comprising a visual representation of the live view and the icon. The visual overlay is generated based on the sensor data. The icon is indicative of the plurality of possible actions associated with the measurement. An icon is a graphic symbol or image that represents a software application, file, folder, and/or action on a processing circuitry, e.g., part of a computer. The icon can be designed to be easily recognizable and memorable. For example, the icon can be designed to use simple and minimalistic visuals, e.g., to inform the user about a selected measurement. For example, the icon can use metaphors or symbols to convey meaning and functions, such as a displaying multiple possible new measurements in conjunction with the geometry element.

A possible action can be a generation of a geometry element, a selection of a pre-existing geometry element, a selection of a measurement parameter and/or a definition of the measurement parameter. For example, the plurality of possible actions may allow the user setting up of the measurement for process control.

The icon can be indicative of the plurality of possible actions. Thus, the user can be informed by the icon about each possible action of the plurality of possible actions for the measurement. Alternatively, the icon can present only a part of possible actions of the plurality of possible actions. For example, the icon can show x different measurement parameters and can be indicative of y different measurement parameters, with x<y. In this way, the recognizability of the icon can be increased. In this case, each possible action of the plurality of possible actions can be displayed to the user using the second visual overlay as described below.

The live view refers to a real-time display of the sample 110. For example, a live view may allow the user to see a continuous and up-to-date display of the sample 110 being acquired by the microscope.

A live view can be particularly useful in process control microscopy applications, as it allows the user to see an image of the sample 110 in real-time and make adjustments to the microscope or sample 110 as needed.

For example, a live view may be used to inspect and monitor the quality of a work piece during the manufacturing process, or to adjust the focus and positioning of the microscope to ensure that the live view is properly acquired.

The live view may be presented in a separate window or as a portion of a main application window. The live view window may be accompanied by the icon, e.g., as part of a configuration panel. Additionally or alternatively, the icon may be integrated into the live view window. For example, the icon can be used to configure a measurement of an optical inspection such as a dimensional measurement of the sample 110.

For example, the measurement may be an optical inspection such as surface inspection, texture analysis, defect detection, dimensional measurement. The icon may provide a (first) selection for the user. For example, multiple icons may be displayed, each assigned to different measurements. The measurement can involve the measurement of a measurement parameter such as length, width, height, diameter, radius, roughness, texture of the sample 110, e.g., a structure of the sample 110. Thus, an icon can be defined for the measurement of at least one measurement parameter.

A dimensional measurement refers to a process of determining a size and dimension of a structure. For example, a dimensional measurements may be used to inspect and verify the size and dimensions of work pieces, e.g., the sample 110, during the manufacturing process. This is done to ensure that the work piece meets the required specifications and standards, and to detect any deviation or defect that may affect the quality or performance of the work piece.

Dimensional measurements can be performed on a wide range of materials and work pieces, including metal parts, plastic components, and electronic devices. Thus, a selection of a desired optical inspection, e.g., a dimensional measurement, can be complicated.

Therefore, the apparatus 130 is further configured to transmit a display signal indicative of the visual overlay. For example the display signal can be transmitted to a display device 330 or a storage device, such like a frame buffer. The optical imaging system 100 may comprise the display device 330. Alternatively, the display device 330 may be external to the optical imaging system 100, e.g., communicatively coupled to the optical imaging system 100.

The display signal may comprise information about the visual overlay, e.g., the sensor data or may compromise the sensor data and data about a visual representation of the icon, such like information about an element representing the icon on a displayed graphical user interface (GUI). In this way, the display device 330 can be used to display the live view in combination with the icon. Optionally, the display signal may comprise data to control the display device 330. Thus, the apparatus 130 can trigger display the visual overlay on the display device 330.

By displaying the icon on the display device setting up a measurement for process control can be facilitated. For example, a number of clicks required for setting up the measurement for process control can be reduced. Multiple clicks may be required to define the measurement for process control. For example, a measurement for process control may comprise a generation/selection of a (pre-existing) geometry element and a selection of the measurement parameter. By selecting the icon the user can start the workflow to set up the measurement for process control using only one icon.

Further, the visual overlay can provide a user information about measurement parameters and/or geometry elements associated with measurement. In this way, the user can easily select a desired measurement parameter and/or geometry element.

The icon can reduce the number of clicks required for setting up the measurement, e.g., a selection of an icon to define the geometry element and another icon to define the measurement parameter can be omitted. Thus, a time required to execute the task of setting up a measurement can be reduced. Further, a GUI can be less lean. For example, a configuration panel comprising the icon may be less crowded. Thus, the user can easily set up a measurement for process control and/or a user experience may be increased.

Instead of using distinct icons/buttons for creating a geometry element (or secondary geometry elements needed for the measurement) and measurement parameters multiple possible solutions (e.g., measurements: angle, circle-to-circle, circle-to-line, circle-to-point; secondary geometry elements: tangents between circles, tangents between circle and point, bisector) and the respective function can be selected using a click on a (single) icon (e.g., for angle measurement). Thus, the selection of the icon can start a workflow to easily set up the measurement. For example, the second visual overlay may enable a user to select and/or generate a geometry element/measurement parameter directly in the live view, e.g., by mouse controls.

For example, if a secondary geometry element needs to be created, the apparatus 130 can generate an adapted second visual overlay to present possible secondary geometry elements in the live view, e.g., after a primary geometry element has been selected by the user (e.g., information about this selection can be received by the third trigger signal). Thus, the user can receive information about secondary geometry elements associated with the geometry element belonging to the measurement.

A selection of type of geometry element and/or measurement parameter to be selected/defined can done by clicking on the icon. The icon may graphically represent all possible variants within a single image for a simplified user interface. In this way, setting up the measurement can be facilitated.

Embodiments of the present disclosure are built around two main components-the microscope, which comprises the optical components, and which may house the display device 330 being used to view the sample 110, and the apparatus 130, which is used to control the optical imaging system 100, process sensor data of the microscope, e.g., the sensor 122, and to generate a display signal.

In general, an optical microscope system 100 comprises a microscope that is suitable for examining objects that are too small to be examined by the human eye (alone). For example, a microscope may provide an optical magnification of a sample, such as a sample 110 shown in FIG. 1. Thus, a structure of the sample 110, e.g., formed by a manufacturing step, can be magnified and measured with increased precision. In modern microscopes, the optical magnification is often provided for a camera or an imaging sensor, such as the optical imaging sensors 122 of the microscope. The microscope may further comprise one or more optical magnification components that are used to magnify a view of the sample 110, such as an objective.

There are a variety of different types of optical imaging systems. For example, the optical imaging system 100 may be used for process control. The optical imaging system 100 may comprise an optical system, a camera or detector and a monitor or a display device 330. The optical system may typically comprise optical parts, such like lenses, mirrors, or other optical components that work together to produce a high-resolution image, e.g., the live view, of the sample 110. The camera or detector, e.g., the sensor 122, may be used to acquire the live view, e.g., the live view, of the sample 110 and converts it into a digital signal that can be displayed on the display device 330 and/or analyzed using a software, e.g., performed by the apparatus 130.

The display device 330 may be used to display the live view acquired by the sensor 122, as well as any additional information such as measurement data, analyzes methods, the icon, e.g., in the configuration panel, or the possible actions for the measurements.

In an example, the apparatus 130 may be further configured to receive a trigger signal indicative of selection of the icon by the user and generate a second visual overlay comprising a visual representation of the live view and a visual presentation of the plurality of possible actions. The generation of the second visual overlay is based on the sensor data and the trigger signal. The trigger signal may be a first trigger signal. Further, the apparatus 130 may be configured to transmit a second display signal indicative of the second visual overlay. For example, the second display signal can be transmitted to the display device 330 or a storage device, such like a frame buffer. The first trigger signal may be received from an input device or a storage device. An input device may be a keyboard and/or controller, which can include a mouse, trackball, touch screen, voice-recognition device, or any other device that permits a system user to input information into.

The second visual overlay can be used to display multiple, e.g., each, possible action of the plurality of possible actions to the user wires display device 330. In this way, the user can receive, after selection of the icon, an overview about possible actions associated with the measurement associated with the icon. Thus, the user can be informed in a facilitated way about geometry elements and/or measurement parameters associated with the measurement. Therefore, multiple icons (distinct icons/buttons for creating a geometry element and measurement parameters with multiple possible solutions) for multiple geometry elements/measurement parameters associated with the measurement can be omitted.

In an example, the apparatus 130 may be further configured to receive a second trigger signal indicative of an increased likelihood to select an action of the plurality of possible actions. The second trigger signal may be received from an input device (e.g., the same input device as for the first trigger signal) or a storage device. The selection may be performed by a user. Further, the apparatus 130 may be configured to adapt the second visual overlay by highlighting the action (with an increased likelihood to be selected by the user) of the plurality of possible actions. The adaption may be based on the second trigger signal. Further, the apparatus 130 may be configured to transmit the adapted second display signal, e.g., to the display device 330 or a storage device, such like a frame buffer. The second visual overlay may provide a user an assistance for setting up the measurement. For example, the second visual overlay may be to highlight the possible selection of the user. The user can be informed in advance of a selection or the possibility, e.g., a click with a mouse cursor, at a certain position may lead to an intended action. For example, the second visual overlay may be to highlight a geometry element close to or below a mouse cursor (e.g., during mouseover). For example, at geometry element can be highlighted during a mouseover. For example, the apparatus 130 may receive information about the mouseover wire the second trigger signal. The second trigger signal can be indicative of the mouseover. Thus, the user can receive visual feedback before selecting a pre-existing geometry element, for example.

For example, multiple measurement parameters can be associated with the measurement associated with the icon selected by the user. The multiple measurement parameters, e.g., distance measurement from a center of the circle to a second geometry element or from an edge of the circle to the second geometry element, can be displayed on the display device 330. However, the multiple measurement parameters may be crowded. Thus, by highlighting the measurement parameter likely to be selected by the user and/or associated with a position of the mouse cursor a user experience can be increased.

Additionally or alternatively, the second visual overlay may be to highlight possible secondary geometry elements in the live camera view after a primary geometry element(s) has (have) been selected. This can be performed independently of the position of a mouse cursor. For example, after selection of a primary pre-existing geometry element or generation of a primary new geometry element the second visual overlay may highlight possible secondary geometry elements associated with the primary geometry element to define the measurement for process control. The apparatus 130 may receive information about a selection/generation of the primary geometry element via the third trigger signal. The desired secondary geometry elements can then be selected by the user by clicking on it, for example. In this way, the user can receive a visual feedback about possible secondary geometry elements. For example, the user may receive information about a selection of a pre-existing geometry element by the user based on the third trigger signal as described herein.

In an example, the second visual overlay may be to highlight a measurement parameter and/or a pre-existing geometry element. For example, in case a measurement is to be performed, the respective measurement can be shown upon mouseover over the respective area (e.g., different angles of two intersecting lines). For example, the apparatus 130 may receive information about the mouseover by receiving the second trigger signal. Thus, the apparatus 130 can highlight a measurement parameter associated with the respective area in the second visual overlay. By transmitting the second visual overlay, e.g., to the display device 330 or a storage device, such like a frame buffer, the user can be informed about the measurement parameter. Then, the user can select the measurement parameter upon clicking on it.

In an example, the second visual overlay may comprise a representation of each possible action of the plurality of actions associated with the selected icon. For example, the apparatus 130 may receive information about the selection of the icon via the second trigger signal. Based on the second trigger signal the apparatus 130 may generate the second visual overlay to display the user each possible action associated with the measurement associated with the selected icon. In this way, the user can receive information about each possible action he can perform. Thus, user experience may be increased and/or setting up a measurement may be facilitated.

In an example, the multiple possible actions may comprise generating a geometry element and/or defining a measurement parameter. For example, an action may be any task related to the measurement, especially to setting up the measurement.

In an example, the multiple possible actions may comprise different geometry elements to be generated and/or selected. For example, the measurement may comprise a primary geometry element and a second geometry element. A first possible action may be to generate/select the primary geometry element. A second possible action may be to generate/select the secondary geometry element. The second visual overlay can present both the primary geometry element and the secondary geometry element. As described herein highlighting of the secondary geometry element can be performed based on a selection of the primary geometry element.

In an example, the multiple possible actions may comprise different measurement parameters to be defined. For example, a dimensional measurement may comprise the measurement parameter such like an angle, circle-to-circle, circle-to-line, circle-to-point, tangents between circles, tangents between circle and point, bisector may be associated with the icon. Therefore, the multiple measurement parameters can be displayed to the user, such that the user can easily select a desired measurement parameter.

In an example, the apparatus 130 may be further configured to receive a third trigger signal indicative of selection of the pre-existing geometry element by the user. The third trigger signal may be received from an input device (e.g., the same input device as for the first trigger signal) or a storage device. Further, the apparatus 130 may be configured to generate the second visual overlay and/or the adapted second visual overlay based on the third trigger signal. For example, if multiple geometry elements are needed for defining a measurement, the apparatus 130 can highlight only geometry elements which can be used in conjunction with the selected pre-existing geometry element. For example, the apparatus 130 may receive information about a selection of a pre-existing geometry element via the third trigger signal. The selected pre-existing geometry element may be assigned as primary geometry element. Thus, the apparatus 130 can determine possible secondary geometry elements associated with the primary geometry element. The apparatus 130 can further adapt the second visual overlay based on the possible secondary geometry elements. In this way, the user can receive an adapted second visual overlay displaying only possible secondary geometry elements.

In an example, the selected pre-existing geometry element may be a primary geometry element and the adapted second visual overlay may comprise a highlight of a possible secondary geometry element. The possible secondary geometry element may be a geometry element which can be used to run a measurement in conjunction with the primary geometry element. In this way, the user can receive a visual representation of possible geometry elements to set up the measurement.

In an example, the apparatus 130 may be further configured to receive a fourth trigger signal indicative of selection of an action of the plurality of possible actions and generate a geometry element and/or perform a measurement based on the fourth trigger signal. The fourth trigger signal may be received from an input device (e.g., the same input device as for the first trigger signal) or a storage device. In this way, the apparatus can perform certain measures to allow setting up and/or run the measurement for process control. Thus, different measurements can be set up. Setting up a measurement may rely on the first trigger signal and the second trigger signal and/or the third trigger signal and/or the fourth trigger signal.

For example, a user may select the icon and an exemplary workflow as follow may start. The apparatus 130 may generate the second visual overlay. The second visual overlay may comprise the plurality of possible actions associated with the measurement associated with selected icon. The user may move the mouse cursor and the apparatus 130 may receive the second trigger signal. The second trigger signal may be indicative of a mouseover. The apparatus 130 may generate an adapted second visual overlay based on the second trigger signal, e.g., highlighting a pre-existing geometry element associated with the mouseover. Thus, the user can be informed about a possible selection of the pre-existing geometry element during mouseover. The user may select the highlighted pre-existing geometry element by clicking on it during the mouseover. The apparatus 130 may receive information about the selection of the pre-existing geometry element by the user via the third trigger signal. The apparatus 130 may adapt the second visual overlay based on the third trigger signal, e.g., to highlight possible secondary geometry elements associated with the selected pre-existing geometry element. Thus, the user can be informed about possibilities to select the secondary geometry element. The apparatus 130 may receive information about the selection of the secondary geometry element by the user by via another third trigger signal. The apparatus 130 may adapt the second visual overlay based on the other third trigger signal, e.g., to display possible measurement parameters. Thus, the user can be informed about a selection of measurement parameters. The user may move the mouse cursor and the apparatus 130 may receive another second trigger signal. The other second trigger signal may be indicative of a mouseover associated with a measurement parameter. The apparatus 130 may generate an adapted second visual overlay based on the other second trigger signal, e.g., highlighting a measurement parameter associated with the mouseover. Thus, the user can be informed about a possible selection of the measurement parameter. The user can select the highlighted measurement parameter by clicking on it. The apparatus 130 may receive information about the selection of the measurement parameter by the fourth trigger signal. In this way, the user can easily set up a measurement for process control. This workflow is for illustration purposes only. The number of trigger signals and/or the order and/or the used trigger signals may vary.

As shown in FIG. 1 the optional one or more interfaces 132 is coupled to the respective one or more processors 134 at the apparatus 130. In examples the one or more processors 134 may be implemented using one or more processing units, one or more processing devices, any means for processing, such as a processor, a computer or a programmable hardware component being operable with accordingly adapted software. Similar, the described functions of the one or more processors 134 may as well be implemented in software, which is then executed on one or more programmable hardware components. Such hardware components may comprise a general-purpose processor, a Digital Signal Processor (DSP), a micro-controller, etc. The one or more processors 134 is capable of controlling the one or more interfaces 132, so that any data transfer that occurs over the one or more interfaces 132 and/or any interaction in which the one or more interfaces 132 may be involved may be controlled by the one or more processors 134.

In an embodiment the apparatus 130 may comprise a memory, e.g., the one or more storage devices 136 and at least one or more processors 134 operably coupled to the memory and configured to perform the method described below.

In examples the one or more interfaces 132 may correspond to any means for obtaining, receiving, transmitting or providing analog or digital signals or information, e.g., any connector, contact, pin, register, input port, output port, conductor, lane, etc. which allows providing or obtaining a signal or information. The one or more interfaces 132 may be wireless or wireline and it may be configured to communicate, e.g., transmit or receive signals, information with further internal or external components.

The apparatus 130 may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system. The apparatus 130 may be part of the optical imaging system 100. Alternatively, the apparatus 130 may be external to optical imaging system 100, e.g., may be part of a display device 330.

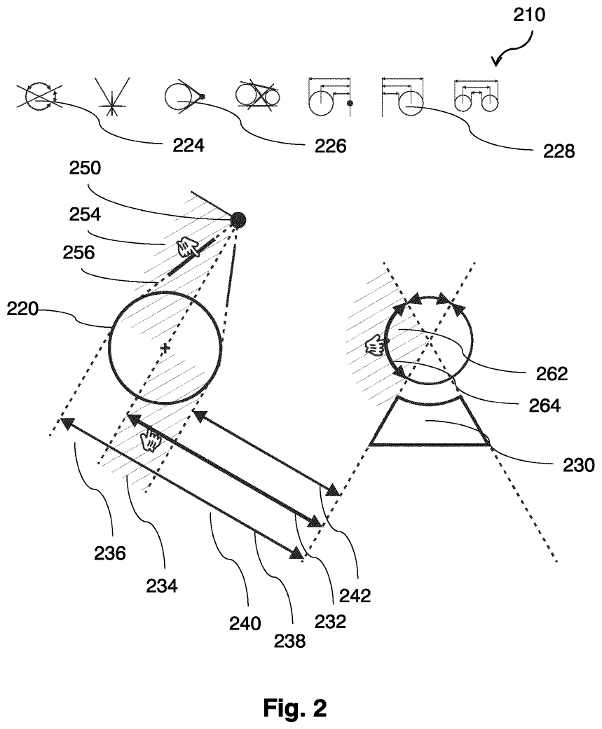

More details and aspects are mentioned in connection with the examples described below. The example shown in FIG. 1 may comprise one or more optional additional features corresponding to one or more aspects mentioned in connection with the present disclosure or one or more examples described below (e.g., FIG. 2-5).

FIG. 2 shows an example of multiple possible actions. For reasons of illustration more than one mouse cursor is shown in FIG. 2. As described above the multiple possible actions may be displayed in overlay with a live view of the sample.

As can be seen in FIG. 2 the multiple possible actions belong to multiple measurement parameters. For example, a distance between the circle 220 and the trapezoid 230 can be measured. However, there may be different measurement parameters, i.e., possibilities to measure the distance between the circle 220 and the trapezoid 230, e.g., from a center of the circle 220 or an edge of the circle 220. During a mouseover the apparatus (e.g., the apparatus described with reference to FIG. 1) can generate a second adapted visual overlay to highlight a measurement parameter, e.g., the measurement parameter 232 form the center of the circle 220. The measurement parameter 232 can be highlighted if the mouse cursor is in the region 234. For example, the region 234 may be assigned to the measurement parameter 232. Thus, the user can easily select a desired measurement parameter based on several regions defined in the live view. Optionally the region 236 may be assigned to the measurement parameter 238 and the region 240 may be assigned to the measurement parameter 242. For example, the apparatus may generate the second visual overlay based on the selection of the icon 228. The apparatus may receive information about the selection of the icon 228 via the first trigger signal.

For example, a second measurement may be a measurement of a tangent. The tangent may be measured from a point 250. The second measurement can be selected by click on the icon 226. During mouseover in region 254 the tangent 256 may be highlighted. For example the third measurement may be a measurement of an angle associated with the trapezoid 230. The third measurement can be selected by a click on the icon 224. During mouseover in region 262 the measurement parameter 264 may be highlighted.

Using the icons in the configuration panel 210 less checkboxes/icon options to define a specific geometry element and/or measurement parameter are needed. Further, an intuitive user interaction with the live image by providing a visual overlay can be provided. The overlay may enable the user to unambiguous select a desired geometry element and/or a measurement parameter. In this way the user can receive visual representation of an action is going to select.

Additionally or alternatively, touch control can be used to receive a user input. For example, touch control can be enabled if all possible options are shown after selecting the desired geometry element and/or measurement parameter and/or icon. In this case no highlighting of possible action may be required.

More details and aspects are mentioned in connection with the examples described above and/or below. The example shown in FIG. 2 may comprise one or more optional additional features corresponding to one or more aspects mentioned in connection with the present disclosure or one or more examples described above (e.g., FIG. 1) and/or below (e.g., FIG. 3-5).

Some embodiments relate to an optical imaging system comprising an apparatus as described in connection with FIG. 1. Alternatively, an optical imaging system may be part of or connected to an apparatus as described in connection with FIG. 1.

FIG. 3 shows a schematic illustration of a system 300, e.g., an optical imaging system 300. The optical imaging system 300 may comprise an apparatus as described with reference to FIG. 1 and a display device 330. The display device 330 may be part of a computer system 320. For example, the microscope 310 may comprise or can be communicatively coupled to the apparatus. Alternatively, the computer system 320 may comprise the apparatus. The microscope 310 can be communicatively coupled to the display device 330. Thus, the apparatus can transmit the display signal from the microscope 310 to the display device 330 or a storage device, such like a frame buffer.

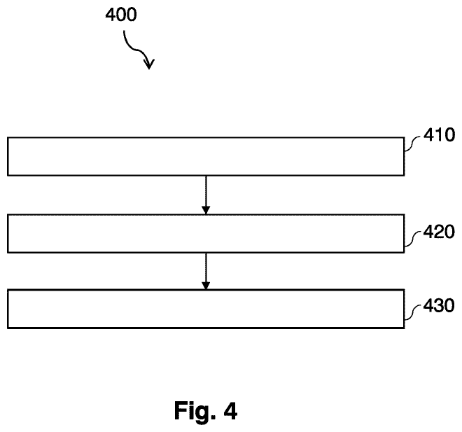

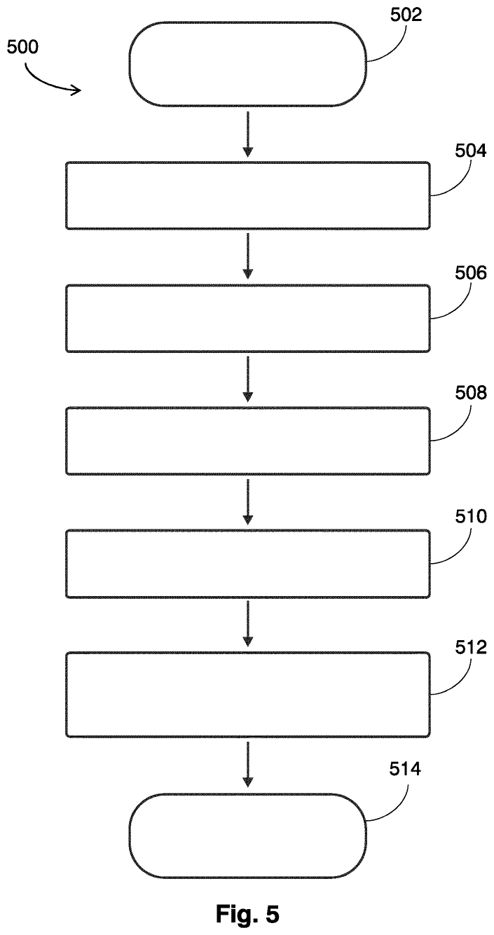

FIG. 3 shows a schematic illustration of a system 300 configured to perform a method described herein, e.g., with reference to FIG. 4 or FIG. 5. The system 300 comprises a microscope 310 and a computer system 320. The microscope may comprise the apparatus as described above, e.g., with reference to FIG. 1. The microscope 310 is configured to take images and is connected to the computer system 320. The computer system 320 is configured to execute at least a part of a method described herein. The computer system 320 may be configured to execute a machine learning algorithm. The computer system 320 and microscope 310 may be separate entities but can also be integrated together in one common housing. The computer system 320 may be part of a central processing system of the microscope 310 and/or the computer system 320 may be part of a subcomponent of the microscope 310, such as a sensor, an actor, a camera or an illumination unit, etc. of the microscope 310.

The computer system 320 may be a local computer device (e.g., personal computer, laptop, tablet computer or mobile phone) with one or more processors and one or more storage devices or may be a distributed computer system (e.g., a cloud computing system with one or more processors and one or more storage devices distributed at various locations, for example, at a local client and/or one or more remote server farms and/or data centers). The computer system 320 may comprise any circuit or combination of circuits. In one embodiment, the computer system 320 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g., camera) or any other type of processor or processing circuit. Other types of circuits that may be included in the computer system 320 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 320 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 320 may also include a display device, one or more speakers, and a keyboard and/or controller, which can include a mouse, trackball, touch screen, voice-recognition device, or any other device that permits a system user to input information into and receive information from the computer system 320.

More details and aspects are mentioned in connection with the examples described above and/or below. The example shown in FIG. 3 may comprise one or more optional additional features corresponding to one or more aspects mentioned in connection with the present disclosure or one or more examples described above (e.g., FIG. 1-2) and/or below (e.g., FIG. 5).

FIG. 4 shows a flow chart of an example of a method 400. The method 400 for an optical imaging system comprises receiving 410, from the optical imaging system, sensor data of a sensor of the optical imaging system. The sensor data is indicative of a live view of a sample through a microscope of the optical imaging system. Further, the method 400 comprises generating 420, based on the sensor data, a visual overlay comprising a visual presentation of the live view and a configuration window. The configuration window is for configuring a measurement of the sample. Further, the method 400 comprises transmitting 430 a display signal indicative of the visual overlay. The display signal may be transmitted to a display device or a storage device, such like a frame buffer, part of the optical imaging system. The method 400 may be performed by an apparatus as described with reference to FIG. 1.

More details and aspects are mentioned in connection with the examples described above and/or below. The example shown in FIG. 3 may comprise one or more optional additional features corresponding to one or more aspects mentioned in connection with the present disclosure or one or more examples described above (e.g., FIG. 1-3) and/or below (e.g., FIG. 5).

FIG. 5 shows a flow chart of another example of a method 500. The method 500 may be performed by an apparatus (as described with reference to FIG. 1.) in conjunction with a display device and an input device.

In 502 the method 500 starts. In 504 and of an icon can be performed by the user. The selection of the icon can be performed by using an input device such like a mouse, a touchpad, keyboard. Information about a selection of the icon can be received at the apparatus.

The icon may be associated with a measurement parameter and/or a geometry element. Based on the information about the selection of the icon the apparatus can generate a second visual overlay. The generated second visual overlay can be transmitted from the apparatus to the display device.

The second visual overlay (comprising the live view of the sample) can be displayed on the display device. In 506 the user may select and/or generate a geometry element. For example the user can select the geometry element by clicking on a pre-existing geometry element. Information about the selection of a pre-existing geometry element and/or a generation of a geometry element can be received at the apparatus. Based on this information the apparatus can generate an adapted second visual overlay. The adapted second visual overlay may be indicative of all possible actions. The adapted second visual overlay may be transmitted from the apparatus to the display device.

The display device may display all possible actions in 508. In 510 a possible action can be highlighted during mouseover on the display device. In 512 the user may select a measurement parameter and/or a geometry element, especially with a single click. Information about the selection of the geometry element and/or the measurement parameter in 512 can be transmitted to the apparatus. The apparatus can run the measurement based on this information. In 514 the method can end.

More details and aspects are mentioned in connection with the examples described above. The example shown in FIG. 4 may comprise one or more optional additional features corresponding to one or more aspects mentioned in connection with the present disclosure or one or more examples described above (e.g., FIG. 1-4).

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

If some aspects have been described in relation to a device or system, these aspects should also be understood as a description of the corresponding method and vice versa. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

The aspects and features described in relation to a particular one of the previous examples may also be combined with one or more of the further examples to replace an identical or similar feature of that further example or to additionally introduce the features into the further example.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 optical imaging system
110 sample
122 sensor
130 apparatus
132 interface
134 processor
136 storage device
200 configuration panel
220 circle
224, 226, 228 icon
230 trapezoid
232, 238, 242, 256, 264 measurement parameter
236, 234, 240, 254, 262 region associated with a measurement parameter
250 point
300 system
310 microscope
320 computer system
330 display device
400 method
410 receiving sensor data of a sensor of the optical imaging system
420 generating a visual overlay
430 transmitting a display signal indicative of the visual overlay
500 method
502 start method
504 select measurement parameter/geometry element
506 select/generate geometry element
508 show possible action
510 highlight during mouseover
512 select desired measurement parameter/geometry element
514 end method

1. An apparatus for an optical imaging system, comprising one or more processors and one or more storage devices, wherein the apparatus is configured to:
receive, from the optical imaging system, sensor data of a sensor of the optical imaging system, the sensor data indicative of a live view of a sample through a microscope of the optical imaging system;
generate, based on the sensor data, a visual overlay comprising a visual representation of the live view and an icon indicative of a plurality of possible actions associated with a measurement; and
transmit a display signal indicative of the visual overlay.

2. The apparatus-according to claim 1, wherein the apparatus is further configured to:
receive a trigger signal indicative of a selection of the icon by a user;
generate, based on the sensor data and the trigger signal, a second visual overlay comprising the visual representation of the live view and a visual representation of the plurality of possible actions; and
transmit a second display signal indicative of the second visual overlay.

3. The apparatus according to claim 2, wherein the apparatus is further configured to:
receive a second trigger signal indicative of an increased likelihood to select, by the user, an action of the plurality of possible actions;
adapt, based on the second trigger signal, the second visual overlay by highlighting the action of the plurality of possible actions; and
transmit the adapted second display signal.

4. The apparatus according to claim 3, wherein
the second visual overlay is to highlight at least one of a measurement parameter or a pre-existing geometry element.

5. The apparatus according to claim 2, wherein
the second visual overlay comprises a representation of each possible action of the plurality of actions associated with the selected icon.

6. The apparatus according to claim 1, wherein
multiple possible actions of the plurality of possible actions comprise at least one of generating a geometry element or defining a measurement parameter.

7. The apparatus according to claim 6, wherein
the multiple possible actions comprise different geometry elements to be generated.

8. The apparatus according to claim 6, wherein
the multiple action comprise different measurement parameters to be defined.

9. The apparatus according to claim 3, wherein the apparatus is further configured to:
receive a third trigger signal indicative of a selection of a pre-existing geometry element by the user; and wherein
generating at least one of the second visual overlay or an adapted second visual overlay is further based on the third trigger signal.

10. The apparatus according to claim 9, wherein
the selected pre-existing geometry element is a primary geometry element and the adapted second visual overlay comprises a highlight of a possible secondary geometry element.

11. The apparatus according to claim 9, wherein the apparatus is further configured to:
receive a fourth trigger signal indicative of a selection of the action of the plurality of possible actions; and
at least one of generate the geometry element or perform the measurement based on the fourth trigger signal.

12. An optical system, comprising
an apparatus according to claim 1.

13. A method for an apparatus for an optical imaging system, the method comprising:
receiving, from the optical imaging system, sensor data of a sensor of the optical imaging system, the sensor data indicative of a live view of a sample through a microscope of the optical imaging system;
generating, based on the sensor data, a visual overlay comprising a visual representation of the live view and an icon indicative of a plurality of possible actions associated with a measurement; and
transmitting a display signal indicative of the visual overlay.

14. The method according to claim 13, further comprising:
receiving a trigger signal indicative of a selection of the icon by a user;
generating, based on the sensor data and the trigger signal, a second visual overlay comprising the visual representation of the live view and a visual representation of the plurality of possible actions; and
transmitting a second display signal indicative of the second visual overlay.

15. A tangible, non-transitory computer-readable medium comprising a computer program having program code, which, upon being executed by one or more processors, provides for performance of the method according to claim 13.
